(19) United States
(12) Patent Application Publication
(10) Pub. No.: US 2007/0063998 A1
(43) Pub. Date: Mar. 22, 2007

(54) Self-learning adaptive PACS workstation system and method

(75) Inventor: Prakash Mahesh, Schaumburg, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/231,658

(22) Filed: Sep. 21, 2005

(51) Int. Cl. G06T 15/00

(52) U.S. Cl. 345/419; 715/757

(57) ABSTRACT

Certain embodiments of the present invention provide a method and system for adaptive user interface configuration in a picture archiving and communication environment. Certain embodiments include a user interface configured for execution on a PACS workstation, wherein the user interface presents functionality to a user. The system also includes a registry configured to track usage information for the functionality, wherein the functionality is registered for tracking via the registry. The user interface is reconfigured based on a comparison of the usage information to a threshold. The threshold may include a certain time interval and/or a certain number of uses, for example. The user interface may be reconfigured to hide functionality used less than the threshold, for example. The user interface may be configured to maximize an amount of space available on the user interface for display of images and functionality used more than the threshold, for example.

### BACKGROUND OF THE INVENTION

The present invention generally relates to a user interface for a picture archiving and communication system (PACS). In particular, the present invention relates to an adaptive user interface facilitating optimal usage of a PACS.

A clinical or healthcare environment is a crowded, demanding environment that would benefit from organization and improved ease of use of imaging systems, data storage systems, and other equipment used in the healthcare environment. A healthcare environment, such as a hospital or clinic, encompasses a large array of professionals, patients, and equipment. Personnel in a healthcare facility must manage a plurality of patients, systems, and tasks to provide quality service to patients. Healthcare personnel may encounter many difficulties or obstacles in their workflow.

Healthcare environments, such as hospitals or clinics, include clinical information systems, such as hospital information systems (HIS) and radiology information systems (RIS), and storage systems, such as picture archiving and communication systems (PACS). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

A PACS may connect to medical diagnostic imaging devices and employ an acquisition gateway (between the acquisition device and the PACS), storage and archiving units, display workstations, databases, and sophisticated data processors. These components are integrated together by a communication network and data management system. A PACS has, in general, the overall goals of streamlining health-care operations, facilitating distributed remote examination and diagnosis, and improving patient care.

A typical application of a PACS system is to provide one or more medical images for examination by a medical professional. For example, a PACS system can provide a series of x-ray images to a display workstation where the images are displayed for a radiologist to perform a diagnostic examination. Based on the presentation of these images, the radiologist can provide a diagnosis. For example, the radiologist can diagnose a tumor or lesion in x-ray images of a patient's lungs.

PACS are complicated to configure and to operate. Additionally, use of PACS involves training and preparation that may vary from user to user. Thus, a system and method that facilitate operation of a PACS would be highly desirable. A need exists for a system and method that improve ease of use and automation of a PACS.

Many users may use a single PACS workstation in a healthcare facility. Each user of the PACS workstation may have different preferences and settings with which the PACS workstation is configured. Thus, a system and method that allows multiple users to more easily share a PACS workstation would be highly desirable.

Additionally, system complexity and use by multiple operators for multiple purposes increases a likelihood that incorrect settings may remain between uses. Incorrect or erroneous settings may result in inaccurate images and incorrect diagnoses. Thus, there is a need for a system and method that minimizes a risk of incorrect settings between multiple users and multiple operations.

PACS workstations have a very static user interface. In many cases, users and administrators may control what end users may see and what end users may not see. However, the PACS workstation is not intelligent enough to know what functionality the users are using and what functionality the users are not using. Thus, a typical PACS station workspace is cluttered with many tools and options that are not used for long periods of time. A method or system for tracking feature usage would be highly desirable. A method or system for broadcasting interface updates to PACS workstations would also be highly desirable.

Thus, there is a need for a self-adaptive user interface facilitating optimal usage of a PACS.

### BRIEF SUMMARY OF THE INVENTION

Certain embodiments of the present invention provide a method and system for adaptive user interface configuration in a picture archiving and communication environment based on usage. Certain embodiments provide a method including registering a functionality available via a user interface on a picture archiving and communication system (PACS) workstation, tracking usage of the functionality, comparing the usage of the functionality to a certain threshold, and adjusting a configuration of the user interface based on the comparison. In an embodiment, the threshold includes a certain time interval and/or a certain number of uses, for example.

In an embodiment, the functionality may be hidden or hibernated based on the comparison. Prominence of functionality on the user interface may be adjusted based on the comparison. In an embodiment, functionality usage may be tracked across multiple PACS workstations and/or other PACS systems, for example. In an embodiment, an adjusted user interface configuration may be broadcast to participating PACS workstations. In an embodiment, a user, such a practitioner, an administrator and/or other software preference, may modify the user interface configuration.

Certain embodiments provide an adaptive user interface system for a picture archiving and communication environment. The system includes a user interface configured for execution on a PACS workstation, wherein the user interface presents functionality to a user. The system also includes a registry configured to track usage information for the functionality, wherein the functionality is registered for tracking via the registry. The user interface is reconfigured based on a comparison of the usage information to a certain threshold. In an embodiment, the certain threshold includes a certain time interval and/or a certain number of uses, for example.

In an embodiment, the user interface maintains a profile for a user based on usage information for the user. In an embodiment, the user interface is reconfigured based on most frequently used functionality and/or most recently used functionality, for example. The user interface may be reconfigured to hide functionality used less than the threshold, for example. The user interface may be configured to maximize an amount of space available on the user interface for display of images and the functionality used more than the threshold, for example. Prominence of frequently and/or recently used functionality may be adjusted based on the threshold as well. In an embodiment, the registry broadcasts the user interface reconfiguration to a plurality of PACS workstations.

Certain embodiments provide a computer-readable medium including a set of instructions for execution on a processor. The set of instructions includes a user interface routine configured to provide functionality to a user of a picture archiving and communication system (PACS) via a user interface, a registry routine configured to register functionality available at the PACS for tracking, a tracking routine configured to track usage statistics for the registered functionality, and a configuration routine for configuring the user interface based on the usage statistics for the registered functionality. The usage statistics are compared to a certain threshold to determine priority for display on the user interface. In an embodiment, the threshold includes a certain time interval and/or a certain number of uses, for example.

In an embodiment, the configuration routine configures a parameter associated with the registered functionality. In an embodiment, the configuration routine broadcasts the configuration of the user interface to a plurality of registered PACS. In an embodiment, the configuration routine configures the user interface to maximize an amount of space available on the user interface for display of images and the functionality based on the certain threshold. In an embodiment, the registry routine registers a plurality of functionality available at a plurality of PACS, and the tracking routine tracks usage statistics for the plurality of functionality available at the plurality of PACS.

### BRIEF DESCRIPTION OF SEVERAL VIEWS OF THE DRAWINGS

FIG. 1 illustrates an exemplary picture archiving and communication system used in accordance with an embodiment of the present invention.

FIG. 2 illustrates an adaptive registry for use with a PACS user interface in accordance with an embodiment of the present invention.

FIG. 3 illustrates a flow diagram for a method for adaptive user interface configuration in a picture archiving and communication environment in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

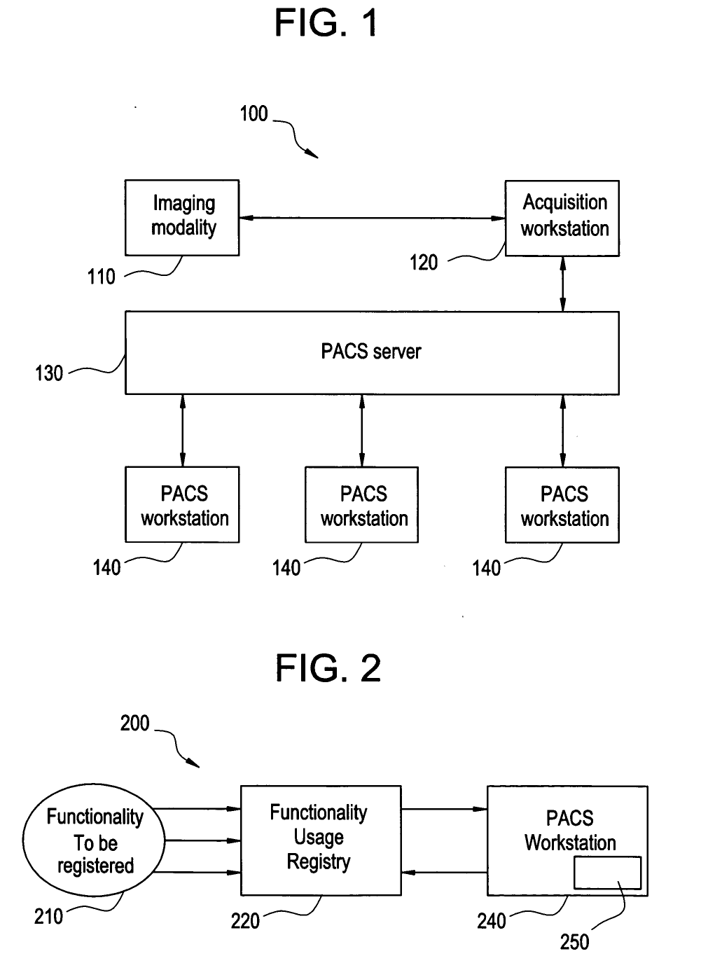

FIG. 1 illustrates an exemplary Picture Archiving and Communication System (PACS) 100 used in accordance with an embodiment of the present invention. The PACS system 100 includes an imaging modality 110, an acquisition workstation 120, a PACS server 130, and one or more PACS workstations 140. The system 100 may include any number of imaging modalities 110, acquisition workstations 120, PACS server 130 and PACS workstations 140 and is not in any way limited to the embodiment of system 100 illustrated in FIG. 1. The components of the system 100 may communicate via wired and/or wireless communication, for example, and may be separate systems and/or integrated to varying degrees, for example.

In operation, the imaging modality 110 obtains one or more images of a patient anatomy. The imaging modality 110 may include any device capable of capturing an image of a patient anatomy such as a medical diagnostic imaging device. For example, the imaging modality 110 may include an X-ray imager, ultrasound scanner, magnetic resonance imager, or the like. Image data representative of the image(s) is communicated between the imaging modality 110 and the acquisition workstation 120. The image data may be communicated electronically over a wired or wireless connection, for example.

In an embodiment, the acquisition workstation 120 may apply one or more preprocessing functions, for example, to the image data in order to prepare the image for viewing on a PACS workstation 140. For example, the acquisition workstation 120 may convert raw image data into a DICOM standard format or attach a DICOM header. Preprocessing functions may be characterized as modality-specific enhancements, for example (e.g., contrast or frequency compensation functions specific to a particular X-ray imaging device), applied at the beginning of an imaging and display workflow. The preprocessing functions differ from processing functions applied to image data in that the processing functions are not modality specific and are instead applied at the end of the imaging and display workflow (for example, at a display workstation 140).

The image data may then be communicated between the acquisition workstation 120 and the PACS server 130. The image data may be communicated electronically over a wired or wireless connection, for example.

The PACS server 130 may include computer-readable storage media suitable for storing the image data for later retrieval and viewing at a PACS workstation 140. The PACS server 130 may also include one or more software applications for additional processing and/or preprocessing of the image data by one or more PACS workstations 140.

One or more PACS workstations 140 are capable of or configured to communicate with the server 130. The PACS workstations 140 may include a general purpose processing circuit, a PACS server 130 interface, a software memory, and/or an image display monitor, for example. The PACS server 130 interface may be implemented as a network card connecting to a TCP/IP based network, but may also be implemented as a parallel port interface, for example.

The PACS workstations 140 may retrieve or receive image data from the server 130 for display to one or more users. For example, a PACS workstation 140 may retrieve or receive image data representative of a computed radiography (“CR”) image of a patient's chest. A radiologist or user may then examine the image for any objects of interest, such as tumors, lesions, etc., for example.

The PACS workstations 140 may also be capable of or configured to apply processing functions to image data. For example, a user may desire to apply processing functions to enhance features within an image representative of the image data. Processing functions may therefore adjust an image of a patient anatomy in order to ease a user's diagnosis of the image. Such processing functions may include any software-based application that may alter a visual appearance or representation of image data. For example, a processing function can include any one or more of flipping an image, zooming in an image, panning across an image, altering a window and/or level in a grayscale representation of the image data, and altering a contrast and/or brightness an image.

In an embodiment, the PACS system 100 may provide one or more perspectives for viewing images and/or accessing applications at a PACS workstation 140. Perspectives may be provided locally at the PACS workstation 140 and/or remotely from the PACS server 130. In an embodiment, the PACS system 100 includes a perspectives manager capable of being used for reviewing images via a plurality of perspectives. The PACS server 130 and/or a PACS workstation 140 may include the perspectives manager, or the perspectives manager may be implemented in a separate system. In an embodiment, each PACS workstation 140 may include a perspectives manager.

In operation, for example, a user, such as a radiologist, selects a set of images, such as screening mammogram images, chest screening images and/or other computed radiography (CR), digital radiography (DR), and/or digital x-ray (DX) screening images, to review at a PACS workstation 140. The images may be displayed in a default perspective, for example. In an embodiment, the default perspective includes all available images in the set. The radiologist may read all views of a patient's breasts from the default perspective, for example. Although the default perspective layout may be crowded, the default perspective allows a user an overall view of a screening. The view from the default perspective allows a user, such as a radiologist, to quickly determine which additional perspective(s) to view.

After viewing the image(s) from a high level, the user may then switch to another perspective. For example, a radiologist switches to a Cranio-Caudal (CC) perspective. Switching to the CC perspective displays CC images of a breast and filters out other images, for example. The CC perspective layout places right CC and left CC images in optimal areas of the perspective layout. Additionally, existing historical CC images from previous screening mammograms may be loaded and displayed. Right and left historical CC images may be displayed in positions relative to the other right and left CC images, for example.

After analyzing the CC images in the CC perspective, the radiologist may then switch to a Medio-Lateral Oblique (MLO) perspective, for example. Switching to the MLO perspective displays MLO images. The MLO perspective layout places right and left MLO images in optimal areas of the perspective layout, for example. Existing historical MLO images from pervious screening mammograms may also be loaded and displayed, for example. Right and left historical MLO images may be displayed in positions relative to the other right and left MLO images, for example.

A user may wish to apply additional processing steps to one or more images to further enhance features in the image. For example, a user may desire to apply additional processing functions or steps to an image in order to alter the presentation of an image in conformance with the user's confidence level for making an accurate diagnosis. In other words, different users may desire to apply different or additional processing steps than are included in a default image processing workflow.

The additional image processing step(s) may include any image processing step useful to prepare an image for a diagnostic examination. For example, as described above, an image processing step (as a default image processing step or an additional image processing step) can include flipping an image, zooming in an image, panning across an image, and altering one or more of a window, a level, a brightness and a contrast setting of an image.

PACS workstations 140 may retrieve or receive image data from server 130 for display to one or more users. For example, a PACS workstation 140 may retrieve or receive image data representative of a computed radiography (“CR”) image of a patient's chest. A radiologist may then examine the image as displayed on a display device for any objects of interest such as, for example, tumors, lesions, etc.

PACS workstations 140 are also capable of or configured to retrieve and/or receive one or more hanging protocols from server 130. For example, a default hanging protocol may be communicated to PACS workstation 140 from server 130. A hanging protocol may be communicated between server 130 and a PACS workstation 140 over a wired or wireless connection, for example.

In general, PACS workstations 140 may present images representative of image data retrieved and/or received from server 130. PACS workstations 140 may present the images according to a hanging protocol. As described above, a hanging protocol is a set of display rules for presenting, formatting and otherwise organizing images on a display device of a PACS workstation 140. A display rule is a convention for presenting one or more images in a particular temporal and/or spatial layout or sequence. For example, a hanging protocol may include a set of computer-readable instructions (or display rules, for example) that direct a computer to display a plurality of images in certain locations on a display device and/or display the plurality of images in a certain sequence or order. In another example, a hanging protocol may include a set of computer-readable instructions that direct a computer to place a plurality of images in multiple screens and/or viewports on a display device. In general, a hanging protocol may be employed to present a plurality of images for a diagnostic examination of a patient anatomy featured in the images.

A hanging protocol may direct, for example, a PACS workstation 140 to display an anterior-posterior (“AP”) image adjacent to a lateral image of the same anatomy. In another example, a hanging protocol may direct PACS workstation 140 to display the AP image before displaying the lateral image. In general, a hanging protocol dictates the spatial and/or temporal presentation of a plurality of images at PACS workstation 140.

A hanging protocol differs from a default display protocol (“DDP”). In general, a DDP is a default workflow that applies a series of image processing functions to image data. The image processing functions are applied to the image data in order to present an image (based on the image data) to a user. The image processing functions alter the appearance of image data. For example, an image processing function may alter the contrast level of an image.

DDPs typically include processing steps or functions that are applied before any diagnostic examination of the images. For example, processing functions may be applied to image data in order to enhance features within an image (based on the image data). Such processing functions can include any software-based application that may alter a visual appearance or representation of image data. For example, a processing function can include any one or more of flipping an image, zooming in an image, panning across an image, altering a window and/or level setting in a representation of the image data, and altering a contrast and/or brightness setting in a representation of the image data.

DDPs are usually based on a type of imaging modality used to obtain the image data. For example, image data obtained with a C-arm imaging device in general or a particular C-arm imaging device may have a same or similar DDP applied to the image data. In general, a DDP attempts to present image data in a manner most useful to many users.

Conversely, applying a hanging protocol to image data does not alter the appearance of an image (based on the image data), but instead dictates how the image(s) is (are) presented, as described above.

Server 130 may store a plurality of hanging protocols and/or DDPs. The hanging protocols and/or DDPs that are stored at server 130 and have not yet been modified or customized are default hanging protocols/DDPs. A default hanging protocol and/or DDP may be selected from a plurality of default hanging protocols and/or DDPs based on any number of relevant factors such as, for example, a manual selection, a user identity, and/or pre-processing of the image data.

Specifically, a default hanging protocol and/or DDP may be selected based on a manual selection simply by communicating the default protocol once a user has selected that particular protocol. The user may make the selection, for example, at a PACS workstation 140.

In another example, a default protocol may be selected based on a user identity. For example, a user may have a preferred DDP. The DDP may have been customized to meet the user's preferences for a particular temporal and/or spatial layout of images. Once a user gains access to a PACS workstation 140 (for example, by entering a correct login and password combination or some other type of user identification procedure), the preferred DDP may be communicated to the PACS workstation 140, for example.

In another example, a default protocol may be selected based on pre-processing of image data. Pre-processing of image data may include any image processing known to those of ordinary skill in the art that prepares an image for review by a user. Pre-processing may also include, for example, a computer-aided diagnosis (“CAD”) of image data. CAD of image data may include a computer (or similar operating unit) automatically analyzing image data for objects of interest. For example, a CAD may include a software application that analyzes image data for nodules in images of lungs, lesions, tumors, etc. However, a CAD application can include any automatic analysis of image data known to those of ordinary skill in the art.

For example, a default hanging protocol that corresponds to CAD findings of lung tumors may provide for the presentation of the posterior-anterior (“PA”) and lateral lung images adjacent to each other followed by the presentation of the computer tomography (“CT”) lung images, followed by the magnetic resonance (“MR”) lung images, for example. In general, a default hanging protocol that corresponds to CAD findings is designed to present images in a spatial and/or temporal layout that is useful to a radiologist. For example, a radiologist may be greatly assisted in his or her review of the CAD findings by viewing the PA and lateral lung images adjacent to each other, followed by previously acquired multi-slice CT and MR images of the lungs.

Therefore, based on CAD findings, a default protocol may be selected from a plurality of default protocols and applied at a workstation 140 in order to present images to a user.

PACS users often wish to run multiple applications on a PACS workstation 140. In addition to a primary PACS workflow or interface application, a user may wish to access other applications such as surgical planning tools, scheduling tools, electronic mail viewers, image processing tools, and/or other tools. For example, PACS users often like to use a PACS workflow engine while viewing electronic mail and accessing information on the Internet. Users of an integrated RIS/PACS system may wish to access both RIS and PACS applications simultaneously.

A PACS workstation, such as the PACS workstation 140, may include a user interface 150 (not shown). The user interface 150 allows a user to access functionality of the PACS workstation 140. The user interface 150 may be a graphical user interface (GUI) or other interface, for example. The user interface 150 allows a user to view and/or process images and other data, perform scheduling and surgical planning, collaborate with other practitioners, and/or execute other applications, for example.

Certain embodiments provide an adaptive user interface 150 that learns as users, such as radiologist, referring physicians, clinicians, technologists, etc., use the PACS. A user, administrator and/or program may register one or more functionality or other option available via the PACS workstation 140. For each registered functionality, the PACS tracks when users use the functionality. If a registered functionality has not been used in more than a preset time interval or other threshold (e.g., a certain number of uses, a certain frequency, or other criteria), then the functionality is moved into “hibernation” or relocated away from the primary user interface 150. For example, hibernating items may be moved to a folder, directory, tab, button, icon, or other location. A user may still access the hibernating functionality, but the functionality is not prominently displayed on the user interface 150. In an embodiment, a user may override a hibernation determination and restore functionality to prominence on the user interface 150.

FIG. 2 illustrates an adaptive registry system 200 for use with a PACS user interface in accordance with an embodiment of the present invention. The system includes functionality to be registered 210, such as PACS controls, viewing/processing options, applications, and/or other functionality. The functionality 210 is registered in the functionality usage registry 220. Functionality 210 may be manually and/or automatically registered in the registry 220 by a user, administrator, and/or program, for example. The registry 220 may store functionality and statistics related to the functionality, such as time of last usage, usage count, usage frequency, and/or other criterion. The registry 220 monitors the PACS workstation 240. The workstation 240 may be similar to the workstation 140 described above, for example. The registry 220 may be updated when registered functionality 210 is used at the workstation 240. Additionally, a user interface 250 displayed at the workstation 240 may be dynamically adjusted based on information from the registry 220. The user interface 250 may be similar to the user interface 150 described above, for example. The components of the registry system 200 may be implemented separately and/or integrated in various forms. In an embodiment, the registry 220 and user interface 250 are implemented on the PACS workstation 240 for functionality 210 available on the PACS workstation 240. The components of the registry system 200 may be implemented in software, firmware and/or hardware, for example.

In an embodiment, the user interface 250 may “learn” preferences and operational behavior for each operator that uses the workstation 240. Thus, the PACS workstation 240 may be customized for each user. Alternatively, the PACS workstation 240 and user interface 250 may be customized for a location, a group of users, and/or uniformly for all users, for example. Customization of the workstation 240 and interface 250 may include menu(s), setting(s), preset(s), layout(s), perspective(s), and/or configuring any setting that may vary from protocol to protocol or from user to user, for example.

In an embodiment, a menu may hide menu items that are infrequently used. The menu shows the menu items that have been recently used and hides the items that have not been recently used. The user interface 250 and/or workstation 240 tracks which menu options are frequently used by a particular user and/or application. Alternatively, the interface 250 and/or workstation 240 may track which menu options are frequently used by all users and/or applications.

In another embodiment, search filter(s) may be automatically populated based upon a most recently and/or most often used search criteria for a given user and/or application, for example. Application scripts or execution shortcuts may also be customized based on most frequently/most recently used options, for example.

In an embodiment, image adjustment settings may include remembering image viewing and/or processing parameters and/or other parameters based on usage by particular user(s) for particular application(s) and/or modality/modalities. Adjustment settings may be stored at the user interface 250 for one or more users based on most recent or most frequent usage, for example.

In another embodiment, presets include remembering preferred settings for one or more users and/or applications on the user interface 250. The most recently used items may be prominently arranged on the user interface 250 while rarely used items are hidden or consolidated on the user interface 250, for example.

In an embodiment, settings are remembered in a Windows-based operating system. However, other operating systems, such as Linux, Unix, OS/2, or other operating system may be used. In an embodiment, options and settings are configured for a user and/or operational mode based on most recently used settings. Alternatively, settings may be configured and saved based on most frequently used settings for a user and/or operational mode. Any selection scheme may be used to store settings or parameters for user(s) and/or mode(s).

A table or other hardware or software structure in the user interface 250 or registry 220 may be used to store data regarding user actions. For example, the user interface 250 and/or registry 220 may track a number of times functionality are used within a given interval. Table 1 illustrates a registry table that may be used to store a certain number of most frequently used functionality in accordance with an embodiment of the present invention. If a functionality is used more than a certain threshold number of times, then the functionality is stored in the registry 220 for display via the user interface 250 at the PACS workstation 240. In an embodiment, most frequently used functionality may be stored in a profile for a user and/or group. Different profiles may be stored for different users and/or operational modes. In an embodiment, a defined number of options may be stored for each profile. Other options may be available under a separate menu item or touch screen tab, for example. In an embodiment, an override is available to allow a user to manually configure a set of functionality to be prominently displayed.

TABLE 1

| | | Number of Times Used |
|---|---|---|
| Feature | Time Last Used | in the Last 72 Hours |
| View Image | 12:05:56 09/18/2005 | 5 |
| View Report | 12:07:50 09/18/2005 | 5 |
| Fast VR | 1:05:56 09/15/2005 | 1 |
| Save Annotation | 12:05:56 09/18/2005 | 2 |

In an embodiment, the registry 220 table may be used to store a certain number of most frequently used functionality. In an embodiment, the table stores user settings in order of most frequent use. The table may be implemented as a first-in, first-out (FIFO) buffer. Thus, if a new functionality reaches a certain usage threshold, the new functionality replaces the least frequently used or lowest entry in the table. Alternatively, the table may store functionality based on most recently used scheme. The table stores functionality and an associated time of last use. A new entry may then replace a table entry with the least recent time of last use. In an embodiment, other storage strategies aside from FIFO, such as last-in, first-out (LIFO) or a threshold-based strategy, may be used to populate the registry 220 table. In an embodiment, registry 220 entries are used by the user interface 250 to construct a graphical user interface display for a user at the PACS workstation 240.

The user interface 250 and/or registry 220 tracks which menu items and/or icons are selected, which parameters are entered, which buttons are pressed, and/or which tabs are touched, for example. The user interface 250 and/or registry 220 may log user keystrokes and/or touches, for example. The user data is stored at the user interface 250, PACS workstation 240 and/or the registry 220, for example. The user data is used to drive the user interface 250 display for a particular user and/or imaging mode.

In another embodiment, the user interface 250 may store a sequence of actions or settings for a user and/or protocol. The sequence may then be represented as a menu option, tab, or button for the user and/or protocol. Selecting the appropriate menu option, tab, or button triggers execution or configuration of the sequence. For example, operator A may prefer to execute a certain series of abdominal scans with varied parameters to check for abnormal growth. The series of scans and varied parameters may be stored such that the operator A selects a smart menu option to execute the series.

In an embodiment utilizing a most frequently used priority scheme, the user interface 250 records user actions/settings and stores functionality in a table or other such structure in the registry 220, PACS workstation 240 and/or user interface 250. A counter value is associated with each functionality. When a counter reaches a certain value, the functionality associated with the counter is maintained on the user interface 250 and/or added to a user or group profile. The functionality may replace functionality with a lower counter value. That is, the new frequently used item replaces an item that has become less frequently used. Counters associated with functionality in a profile allow functionality in the profile to be replaced by other functionality that becomes more frequently used. In an embodiment, counters are refreshed after a certain interval has elapsed. For example, counters associated with functionality are cleared after a month. Thus, a profile may be refreshed based on new patterns of usage.

In an embodiment, items may be arranged on the user interface 250 according to associated usage count values. For example, an item with a usage count of 100 is displayed in a more prominent location than an item with a usage count of 50.

In an embodiment, functionality used less than a certain threshold usage value is hibernated or hidden on the user interface 250. For example, functionality used less than the threshold value may be stored in a little used items folder or accessed by a menu or auxiliary button. In an embodiment, the threshold usage value may be adjusted to create more space for display of images on the user interface 250.

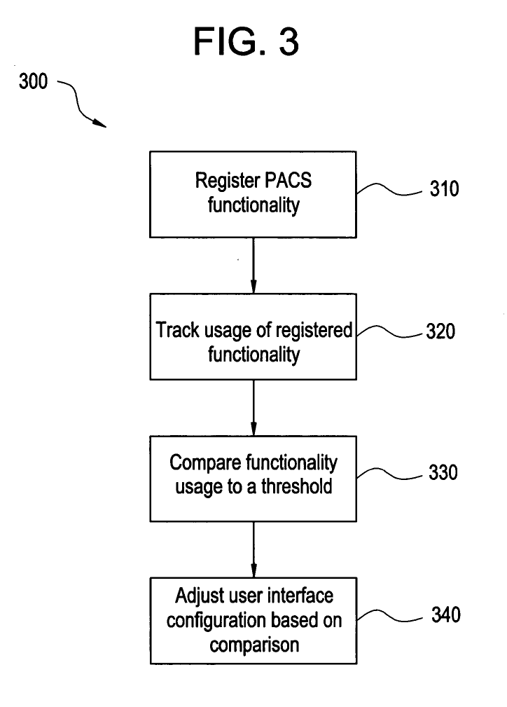

FIG. 3 illustrates a flow diagram for a method 300 for adaptive user interface configuration in a picture archiving and communication environment in accordance with an embodiment of the present invention. First, at step 310, PACS workstation functionality is registered. As described above, PACS workstation items/functionality may be registered using a table, database, data store and/or other registry, for example.

Then, at step 320, usage of the registered functionality is tracked. For example, application launch, item selection, and/or keystrokes may be monitored and logged. Tracking information may be stored in registry 220 or other memory construct, for example. Tracking information may be stored according to a most frequently used, most recently used, least frequently used, least recently used, and/or other scheme, for example. Functionality tracking data may be maintained in a registry 220 or other storage based on a FIFO organization, LIFO organization, threshold, time interval, etc., for example.

At step 330, usage of the registered functionality is compared to a certain threshold. For example, a minimum threshold may be determined by average usage patterns and/or may be a user or administrator specified threshold. Then, at step 340, a configuration of the user interface 250 is adjusted based on the comparison of functionality usage to the threshold value. For example, functionality may be hidden on the user interface 250 based on the comparison of functionality usage to the threshold value. If functionality is used less than the certain threshold, that functionality may be positioned out of primary view on the user interface 250, relocated to a folder or subsidiary menu on the user interface 250, or other such repositioning, for example. Alternatively, prominence of items displayed on the user interface 250 may be determined based on usage. That is, a user's most frequently and/or most recently used functions are featured prominently on the user interface 250 so that the user may more easily and/or efficiently use the PACS workstation. Alternatively, functionality usage data may be used to maximize area available on user interface 250 for display of images.

Certain embodiments allow a user to customize a PACS user interface 250 based on frequency of usage and/or other priority. Certain embodiments allow monitoring of PACS functions at a single PACS workstation 240, all workstations in a PACS environment, all workstations in a hospital or healthcare environment, all workstations in a region, and/or all participating users. Data may be aggregated using one or more registries 220. Feedback is provided from PACS workstation(s) to the registry 200. Data may be aggregated and/or tracked for individual users or groups of users to alter the user interface 250. In an embodiment, a user may override a user interface configuration. In an embodiment, a user may modify and/or further customize a user interface configuration. In an embodiment, a user may provide feedback or input to the registry 220 to affect configuration of items on the user interface 250.

In an embodiment, a user interface configuration may be broadcast to participating PACS workstations 240. For example, all participating workstations may be simultaneously updated via a user interface profile or setting file transmitted to eligible workstations. In an embodiment, a user interface 250 may be automatically adapted on an individual PACS workstation 240 with or without a broadcast update. In an embodiment, a user interface update may accompany an update of software at the PACS workstation 240. The software and interface update may occur automatically and/or at the prompting of a user or program at the workstation 240.

In an embodiment, a PACS includes a computer-readable medium, such as a hard disk, floppy disk, CD, CD-ROM, DVD, compact storage, flash memory and/or other memory. The medium may be in the PACS workstation 240 and/or in a separate system. The medium may include a set of instructions capable of execution by a computer or other processor. The registry, tracking and configuration functions described above may be implemented as instructions on the computer-readable medium. For example, the set of instructions may include a user interface routine configured to provide functionality to a user of a PACS via a user interface. The set of instructions may include a registry routine configured to register functionality available at the PACS for tracking. The set of instructions may also include a tracking routine configured to track usage statistics for the registered functionality. Additionally, the set of instruction may include a configuration routine for configuring the user interface based on the usage statistics for the registered functionality. The usage statistics are compared to a certain threshold to determine priority for display on the user interface. In an embodiment, the threshold includes a certain time interval and/or a certain number of uses, for example.

In an embodiment, the configuration routine configures a parameter associated with the registered functionality. In an embodiment, the configuration routine broadcasts the configuration of the user interface to a plurality of registered PACS. In an embodiment, the configuration routine configures the user interface to maximize an amount of space available on the user interface for display of images and the functionality based on the certain threshold. In an embodiment, the registry routine registers a plurality of functionality available at a plurality of PACS, and the tracking routine tracks usage statistics for the plurality of functionality available at the plurality of PACS.

Thus, certain embodiments assist in optimizing a PACS workspace for important functionality while providing more space for display of images. Certain embodiments allow productivity studies and other data to be assembled based on usage of registered PACS features. Statistical data regarding usage helps PACS developers and third party application developers focus on important tools and useful features, as well as deficiencies in some functionality. Certain embodiments provide a technical effect of providing an adaptive user interface which dynamically adjusts to display functionality to a user, for example.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for adaptive user interface configuration in a picture archiving and communication environment based on usage, said method comprising:
registering a functionality available via a user interface on a picture archiving and communication system (PACS) workstation;
tracking usage of said functionality;
comparing said usage of said functionality to a certain threshold; and
adjusting a configuration of said user interface based on said comparison step.

2. The method of claim 1, wherein said adjusting step further comprises hiding said functionality based on said comparison step.

3. The method of claim 1, wherein said adjusting step further comprises configuring a prominence of said functionality on said user interface based on said comparison step.

4. The method of claim 1, wherein said certain threshold comprises at least one of a certain time interval and a certain number of uses.

5. The method of claim 1, wherein said tracking step further comprises tracking usage of said functionality across a plurality of PACS workstations.

6. The method of claim 1, further comprising broadcasting an adjusted configuration of said user interface to participating PACS workstations.

7. The method of claim 1, further comprising allowing modification of said configuration by a user.

8. An adaptive user interface system for a picture archiving and communication environment, said system comprising:
a user interface configured for execution on a picture archiving and communication system (PACS) workstation, wherein said user interface presents functionality to a user; and
a registry configured to track usage information for said functionality, wherein said functionality is registered for tracking via said registry;
wherein said user interface is reconfigured based on a comparison of said usage information to a certain threshold.

9. The system of claim 8, wherein said certain threshold comprises at least one of a certain time interval and a certain number of uses.

10. The system of claim 8, wherein said user interface maintains a profile for a user based on usage information for said user.

11. The system of claim 8, wherein said user interface is reconfigured based on at least one of most frequently used functionality and most recently used functionality.

12. The system of claim 8, wherein said user interface is reconfigured to hide functionality used less than said certain threshold.

13. The system of claim 8, wherein said user interface is configured to maximize an amount of space available on said user interface for display of images and said functionality used more than said certain threshold.

14. The system of claim 8, wherein said registry broadcasts said user interface reconfiguration to a plurality of PACS workstations.

15. A computer-readable medium including a set of instructions for execution on a processor, said set of instructions comprising:
a user interface routine configured to provide functionality to a user of a picture archiving and communication system (PACS) via a user interface;
a registry routine configured to register functionality available at said PACS for tracking;
a tracking routine configured to track usage statistics for said registered functionality; and
a configuration routine for configuring said user interface based on said usage statistics for said registered functionality, wherein said usage statistics are compared to a certain threshold to determine priority.

16. The set of instructions of claim 15, wherein said configuration routine configures a parameter associated with said registered functionality.

17. The set of instructions of claim 15, wherein said configuration routine broadcasts said configuration of said user interface to a plurality of registered PACS.

18. The set of instructions of claim 15, wherein said registry routine registers a plurality of functionality available at a plurality of PACS, and wherein said tracking routine tracks usage statistics for said plurality of functionality available at said plurality of PACS.

19. The set of instructions of claim 15, wherein said certain threshold comprises at least one of a certain time interval and a certain number of uses.

20. The set of instructions of claim 15, wherein said configuration routine configures said user interface to maximize an amount of space available on said user interface for display of images and said functionality based on said certain threshold.
